(19) United States
(12) Patent Application Publication
(10) Pub. No.: US 2006/0233409 A1
(43) Pub. Date: Oct. 19, 2006

(54) Hearing aid

(75) Inventor: Tom Weidner, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Audiologische Technik GmbH

(21) Appl. No.: 11/404,029

(22) Filed: Apr. 13, 2006

(30) Foreign Application Priority Data
Apr. 15, 2005 (DE) 10 2005 017 493.0

(51) Int. Cl. H04R 25/00

(52) U.S. Cl. 381/326

(57) ABSTRACT

The supply to people with a hearing impairment is to be improved. A hearing aid device is provided for this purpose which has at least two output signal transducers. Thus both an earpiece and a cochlear implant can be triggered, for example by common signal processor, via an induction coil. A hybrid supply to an ear can thus be ensured.

### CROSS REFERENCE TO RELATED APPLICATIONS

This application claims priority to the German Application No. 10 2005 017 493.0, filed Apr. 15, 2005 which is incorporated by reference herein in its entirety.

### FIELD OF INVENTION

The present invention relates to a hearing aid device comprising a signal processing device for obtaining a processing signal from an input signal and an output transduce r with which the processing signal can be converted into an output signal.

### BACKGROUND OF INVENTION

Conventional hearing aids, such as behind-the-ear hearing aids (BTE) or in-the-ear hearing aids (ITE), can be helpful in the case of many hearing impairments. However, a condition of this is that the cochlea is functional. If the cochlea is completely or partially damaged however, so conventional hearing aids do not make any gain in hearing possible, the auditory nerve can nowadays be directly stimulated with the aid of what is known as a cochlear implant (CI) which attempts to replace the function of the cochlea. Thus an acoustic impression may be achieved at least in the high frequency rang e.

Other types of hearing aid are, for example, brain stem implants (ABI; Auditory Brain Stem Implants), which can be used if the auditory nerve is damaged. Bone conduction hearing aids and what are known as BAHAs (Bone Anchored Hearing Aids) are also known for conveying sound via the bones to the middle ear or inner ear.

### SUMMARY OF INVENTION

However, hearing impairments are so varied that for some people with a hearing impairment only a small gain in hearing can be achieved with the known hearing aids.

A fully implantable hearing system which comprises an actuator-based output-side arrangement for stimulating the middle or inner ear, is known from document DE 101 14 838 A1. The actuator-based arrangement comprises at least one electromagnetic transducer for mechanically stimulating the middle or inner ear. The arrangement may also comprise intracochlear stimulation electrodes for stimulating the inner ear by way of electrical stimulation.

Furthermore a hearing aid comprising a speech recognition module and a speech synthesis module is described in patent specification DE 100 31 832 C1. According to a first embodiment the output signal of the module is supplied to an electroacoustic transducer for sound radiation in the outer auditory canal. According to a second embodiment an electromagnetic transducer can be provided which is coupled to the middle or inner ear.

An at least partially implantable system for rehabilitation of a hearing defect is also described in patent specification DE 100 18 334 C1. In this case an actuator-based stimulation arrangement comprises, in combination, an electromechanical transducer for mechanical stimulation of the middle or inner ear and an intracochlear, electrically acting stimulation electrode array with at least one stimulation electrode for electrical stimulation of the inner ear.

An object of the present invention is therefore to propose a hearing aid device with which the gain in hearing can be improved for example in the case of an at least partially damaged cochlea.

This object is achieved by a hearing aid device comprising a signal processing device for obtaining a first processing signal from an input signal and a first output transducer with which the first processing signal can be converted into a first output signal, wherein a second processing signal can be obtained from the input signal by the signal processing device and at least one second output transducer is connected to the signal processing device, with which transducer the second processing signal can be converted into a second output signal. The first output signal of the hearing aid device according to the invention is an acoustic signal and the second output signal is an electromagnetic signal. It is thus possible to provide an amplified acoustic signal for conventional airborne noise-based hearing and an electromagnetic control signal for contactless triggering of an implant with one and the same device.

A hybrid supply can advantageously be provided by the hearing aid device according to the invention, which supply ensures, for example, simultaneous supply with a cochlear implant (or bone conduction hearing aid) and a non-implantable hearing aid (airborne noise-based hearing aid or bone conduction hearing aid or BAHA) in the same ear. A combined airborne noise-based and bone conduction supply would also be possible. For this purpose the hearing aid device can be fitted with a single housing, a common power supply and a common control and signal processor for the two output signals. The adjustment software is accordingly no longer independent either but integrates the various components.

The hearing aid device according to the invention thus jointly uses the technologies of external hearing aids and implants, so a comprehensive hearing system can be provided which is capable of carrying out electrical stimulation and “normal” signal transmission via airborne noise and/or bone conduction. The hard of hearing with very specific hearing loss may thus be offered an imp roved system solution.

It can be particularly advantageous if a control signal for a cochlear implant or brain stem implant can be generated by the signal processing device. An auditory impression may thus be generated even in frequency ranges which can n o longer be attained by the normal method of hearing.

According to a preferred embodiment the second output transducer comprises a transmitting coil. A cochlear implant for example may be inductively triggered hereby.

According to a further variant the second output transducer can be detachably provided on the hearing aid device. A modular construction of the hearing aid device is thus possible. Thus for example a BTE could be fitted with a CI module or a BAHA module, depending on the individual requirement. The first output transducer may also be located outside of the BTE housing in order to integrate the airborne noise transducer (earpiece) into an otoplastic for example.

The hearing aid device can substantially have the external shape of a BTE. Thus a conventional CI controller only has to be fitted with a sound transducer and a corresponding signal processing unit as this unit can also have the shape of a BTE. The hearing aid device can also be constructed as a bone conduction hearing aid or as a hear ing aid anchored to the bone, however. Thus this type of hearing aid may also be combined with a CI for example.

### BRIEF DESCRIPTION OF THE DRAWINGS

The present invention will now be described in more detail with reference to the accompanying drawings, in which:

FIG. 1 shows a combination device of the invention according to a first embodiment and

FIG. 2 shows a combination device of the invention according to a second embodiment.

### DETAILED DESCRIPTION OF INVENTION

The embodiments described hereinafter are preferred developments of the present invention.

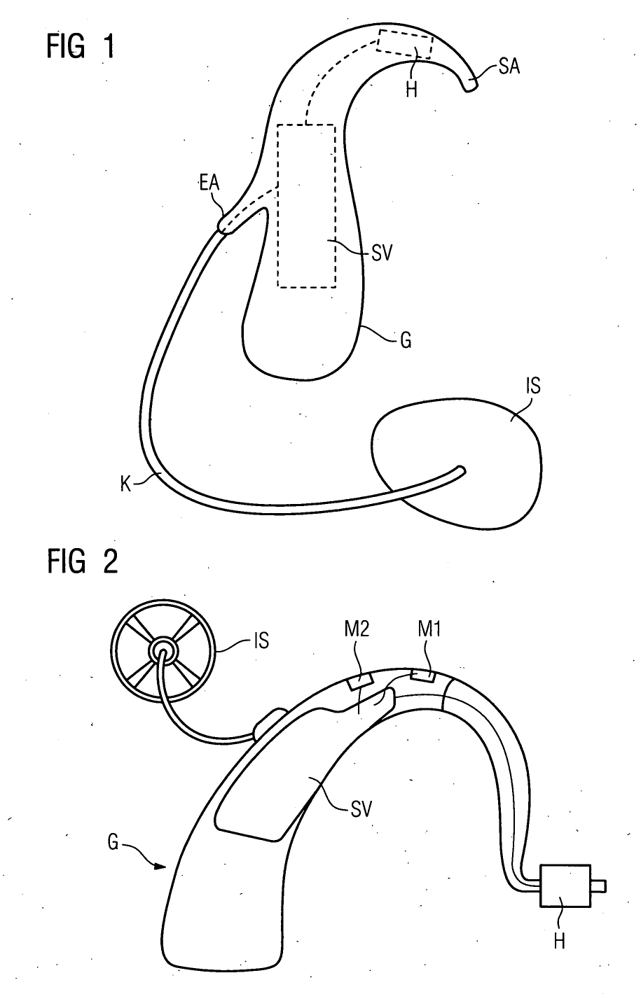

FIG. 1 shows a hearing aid device according to the invention in the form of a combined BTE-CI hearing aid for hybrid supply. It has a substantially BTE housing G. This housing G has two outputs for two physically different supply signals. On the one hand a conventional sound output terminal SA is provided to which a sound tube can be coupled to conduct the airborne noise, for example via an otoplastic, to the eardrum. The corresponding sound is generated by an earpiece H which receives its signals from a si gnal processor SV. However, the signal processor SV not only controls the earpiece H, which is used as a sound transducer, but also generates an electrical signal in order to trigger a cochlear implant. For this purpose a second output terminal EA is provi ded on the housing G in order to provide an electrical signal. An induction coil IS is connected by a cable K to this electrical output terminal EA. A CI (not shown in the figure) can thus be inductively triggered via the induction coil IS. In the process the induction coil IS embedded in a plastics material is provided behind the outer ear on the head of the hearing aid wearer.

It is possible with the hearing aid illustrated above to adequately supply a patient with cochlea impairment. For this purpose for example the low frequencies are supplied to the patient via the CI, while the higher frequencies, for which the patient's cochlea is not impaired, can be presented via the conventional path length of sound waves with appropriate amplification.

In an alternative construction the induction coil IS can also be directly integrated into the housing G. This means that the hearing aid then has roughly the same construction as a BTE that is conventional nowadays. The receiver should be implanted at a suitable location, so the inductive coupling to the CI is sufficiently high.

The signal processor is preferably configured in such a way that acoustic and electrical transducers can be actuated with a single piece of adjustment software. Thus a flexible change in range or an adjustment can be carried out at any time. Changing hearing loss can in particular be reacted to flexibly as a result of this.

Owing to the common signal processor for the earpiece H and the CI component, the CI component can also benefit from signal processing which has developed compared with simple CI devices that are conventional nowadays. A common power supply may also be drawn on which is achieved by mechanical integration of the two devices in one housing.

As has been indicated already, the hearing aid device according to the invention can have any desired type of output transducers. In addition, more than two, namely three, four, etc., output transducers may be provided in the hearing aid. Specific embodiments are thus produced, such as a combined bone conduction CI device, a BAHA-CI device, a BTE-ABI device and the like.

With a modular embodiment the respective hearing aid modules can be used with each other as desired. Thus a change in or upgrade of one or more component(s) is possible.

The signal processor provides at least two different output signals. This provision can be made for example, in terms of time, as a function of the respective hearing situation, or of the frequency of the input signal. For example the CI is only trigge red if the hearing situation is characterized by predominantly high frequencies. The individual components of the hybrid hearing system can thus be triggered exclusively or jointly. This means that the signal processing allows joint access to the two syste ms and regulates flexible range division.

The signal processing unit can be adjusted, with respect to the output signals of the plurality of output transducers, by a single piece of adjustment software in a single adjustment process. The number of output transducers per device is not important in the case of binaural supply.

FIG. 2 shows a second embodiment. The hearing aid shown there basically has the same components as the one in FIG. 1. A directional microphone is also shown here with the two microphones M1 and M2. It can also be seen that the earpiece H is arranged outside of the hearing aid housing G.

1-7. (canceled)

8. A hearing aid, comprising:
a signal processing device for generating first and second processed signals from an input signal;
a first output transducer for converting the first processed signal into a first output signal; and
a second output transducer for converting the second processed signal into a second output signal, wherein
the first output signal is an acoustic signal configured to be received by an eardrum or a bone of an auditory canal, and
the second output signal is an electromagnetic or electrical signal configured to be received by an implant.

9. The hearing aid according to claim 8, wherein the second output signal is a control signal for controlling the implant, the implant being a cochlear or a brain stem implant.

10. The hearing aid according to claim 8, wherein the second output transducer comprises a transmitting coil.

11. The hearing aid according to claim 10, wherein the transmitting coil is integrated into a housing of the hearing aid.

12. The hearing aid according to claim 8, wherein the first or second output transducer is detachably connected to other components of the hearing aid.

13. The hearing aid according to claim 8, wherein the hearing aid is shaped as a behind-the-ear hearing aid.

14. The hearing aid device according claim 8, wherein the hearing aid is configured as a bone-conducting hearing aid.

15. The hearing aid device according claim 8, wherein the hearing aid is configured to be anchored in a bone.
